(19) United States
(12) Patent Application Publication
(10) Pub. No.: US 2025/0336381 A1
(43) Pub. Date: Oct. 30, 2025

(54) LANGUAGE MODEL AUGMENTED AUDIO SELECTION AND GENERATION

(71) Applicant: Output, Inc., Los Angeles, CA (US)

(72) Inventors: Jason Levine, New Paltz, NY (US); Spencer Salazar, Los Angeles, CA (US); Gregg Lehrman, San Anselmo, CA (US); Tony Hsieh, San Mateo, CA (US)

(21) Appl. No.: 18/648,204

(22) Filed: Apr. 26, 2024

(51) Int. Cl. G10H 1/00; G06F 16/632; G06F 16/68

(52) U.S. Cl. CPC G10H 1/0025; G06F 16/632; G06F 16/68; G10H 1/0066; G10H 2210/101

(57) ABSTRACT

The present disclosure relates to a system and method for selecting and generating audio using a large language model. The method includes receiving from a user a text-based prompt for a desired song, generating a song specification from a prompt that includes the text-based prompt and instructions on how to create a suitable instruction file format for representing the requested song, for each of the list of tracks in the song specification, generating a ranked list of potential sound loops matching the song specification for a selected track, selecting a sound loop from the ranked list of potential sound loops for each of the list of tracks, and generating a track specification file including the sound loop selected for each of the list of tracks.

### APPENDIX A

A song specification in a desired song specification file format (json) in response to the text-based prompt, “intro to a scifi adventure movie”.
{
   “bpm range”: [
   80,
   120
],
“scale”: “minor”,
“tracks”: [
   {
      “instrument”: “Synthesizer”,
      “function”: “Chords”,
      “description”: [
         “Futuristic”,
         “Ethereal”,
         “Expansive”,
         “Pulsating”,
         “Shimmering”
      ],
      “genre”: [
         “Electronic”,
         “Ambient”,
         “Experimental”
      ],
      “mood”: [
         “Mystical”,
         “Enigmatic”,
         “Eerie”,
         “Otherworldly”
      ],
      “importance”: “high”,
      “tags”: [
         “futuristic”,
         “ethereal”,
         “expressive”,
         “pulsing”,
         “shimmer”,
         “mystical”,
         “mysterious”,
         “eerie”,
         “electronic”,
         “ambient”,
         “experimental”,
         “chords”
      ],
      “required_tags”: [
         “synth”
      ],
      “forbidden_tags”: [ ]
   {
   “instrument”: “Drums”,
      “function”: “Rhythm”,
      “description”: [
      “Electronic”,
         “Industrial”,
         “Processed”,
         “Punchy”,
         “Groovy”
         ],
      “genre”: [
      “Electronic”,
         “Industrial”
         ],
      “mood”: [
      “Energetic”,
         “Suspenseful”,
         “Dynamic”,
         “Aggressive”
      ],
      “importance”: “high”,
      “tags”: [
         “electronic”,
         “industrial”,
         “processed”,
         “punchy”,
         “groovy”,
         “energetic”,
         “suspenseful”,
         “dynamic”,
         “aggressive”
      ],
      “required tags”: [
         “drum kit”,
         “full beat”
      ],
      “forbidden tags”: [
         “intro”,
         “outro”,
         “fill”
      {
   “instrument”: “Electric Bass”,
   “function”: “Bassline”,
      “description”: [
      “Deep”,
      “Gritty”,
         “Growling”,
         “Resonant”,
         “Thick”
         ],
         “genre”: [
      “Electronic”,
      “Industrial”,
         “Rock”
      ],
      “mood”: [
         “Heavy”,
         “Dark”,
         “Menacing”,
         “Powerful”
      ],
      “importance”: “medium”,
      “tags”: [
         “deep”,
         “gritty”,
         “growl”,
         “resonant”,
         “thick”,
         “heavy”,
         “dark”,
         “menacing”,
         “powerful”,
         “electronic”,
         “industrial”,
         “rock”,
         “bassline”
      ],
      “required tags”: [
         “electric bass”
      ],
      “forbidden_tags”: [ ]
   {
   “instrument”: “Electric Guitar”,
      “function”: “Melody”,
      “description”: [
      “Atmospheric”,
         “Mysterious”,
         “Reverberant”,
         “Sustained”,
         “Wailing”
      ],
      “genre”: [
         “Rock”,
         “Experimental”,
         “Soundtrack”
      ],
      “mood”: [
         “Haunting”,
         “Yearning”,
         “Dramatic”,
         “Emotional”
      ],
      “importance”: “medium”,
      “tags”: [
         “atmospheric”,
         “mysterious”,
         “reverb”,
         “sustained”,
         “howling”,
         “haunting”,
         “tender”,
         “dramatic”,
         “emotional”,
         “rock”,
         “experimental”,
         “soundtrack”,
         “melody”
      ],
      “required tags”: [
         “electric guitar”
      ],
      “forbidden_tags”: [ ]
   {
   “instrument”: “Piano”,
      “function”: “Riff”,
      “description”: [
      “Echoing”,
         “Sparse”,
         “Elegant”,
         “Haunting”,
         “Mysterious”
      ],
      “genre”: [
         “Classical”,
         “Ambient”,
         “Soundtrack”
      ],
      “mood”: [
         “Enigmatic”,
         “Melancholic”,
         “Ethereal”,
         “Reflective”
      ],
      “importance”: “medium”,
      “tags”: [
         “echo”,
         “sparse”,
         “elegant”,
         “haunting”,
         “mysterious”,
         “melancholic”,
         “ethereal”,
         “reverb”,
         “classical”,
         “ambient”,
         “soundtrack”,
         “riff”
      ],
      “required_tags”: [
         “piano”
      ],
      “forbidden_tags”: [ ]
   {
   “instrument”: “Sound Effects”,
      “function”: “FX”,
      “description”: [
         “Electronic”,
         “Processed”,
         “Crackling”,
         “Reverberant”,
         “Unfolding”
      ],
      “genre”: [
         “Experimental”,
         “Soundtrack”
      ],
      “mood”: [
         “Disorienting”,
         “Tense”,
         “Unsettling”,
         “Atmospheric”
      ],
      “importance”: “medium”,
      “tags”: [
         “electronic”,
         “processed”,
         “crackle”,
         “reverb”,
         “evolving”,
         “disorienting”,
         “tense”,
         “unsettling”,
         “atmospheric”,
         “experimental”,
         “soundtrack”,
         “fx”
      ],
      “required tags”: [
         “sound design”
      ],
      “forbidden_tags”: [ ]
   {
      “instrument”: “Synthesizer”,
      “function”: “Pattern”,
      “description”: [
         “Rhythmic”,
         “Arpeggiated”,
         “Glitchy”,
         “Contorted”,
         “Twisting”
      ],
      “genre”: [
         “Electronic”,
         “Experimental”,
         “Soundtrack”
      ],
      “mood”: [
         “Frenzied”,
         “Dynamic”,
         “Unpredictable”,
         “Chaotic”
      ],
      “importance”: “low”,
      “tags”: [
         “rhythmic”,
         “arpeggio”,
         “glitchy”,
         “distorted”,
         “swirl”,
         “frantic”,
         “dynamic”,
         “unstable”,
         “chaotic”,
         “electronic”,
         “experimental”,
         “soundtrack”,
         “pattern”
      ],
      “required tags”: [
         “synth”
      ],
      “forbidden_tags”
   {
      “instrument”: “Synthesize”
      “function”: “Drone”,
      “description”: [
         “Brooding”,
         “Mysterious”,
         “Menacing”,
         “Ominous”,
         “Eerie”
      ],
      “genre”: [
         “Electronic”,
         “Experimental”,
         “Dark Ambient”
      ],
      “mood”: [
         “Murky”
         “Sinister”,
         “Intense”,
         “Oppressive”
      ],
      “importance”: “low”,
      “tags”: [
         “brooding”,
         “mysterious”,
         “menacing”,
         “ominous”,
         “eerie”,
         “cloudy”,
         “sinister”,
         “intense”,
         “electronic”,
         “experimental”,
         “ambient”,
         “drone”
      ],
      “required_tags”: [
         “synth”
      ],
      “forbidden_tags”: [ ]
   }

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to the use of large language models to create audio and, more particularly, to language model audio selection and generation.

### Description of the Related Art

There exist various systems for accessing, generating, or editing audio loops. These systems are primarily used to produce music or for synchronizing, scoring, or altering existing music to films, commercials or television.

A typical use case might involve using a search feature of such audio production software, either the software itself or a plugin to that software, to seek a particular type of instrument in a desired rhythm or to seek a particular type of percussion in a desired rhythm. The user may then layer several different instruments or percussion types into a given length of audio track to thereby generate music. Or, at a minimum, to generate a “beat” or portion of music on top of which additional music may be added. The additional music may be live, such as another instrument played by an individual, a rap incorporated along with the beat, or another vocal performance such as singing, synchronized, or joined with the underlying “beat” or length of audio.

In the process of completing this task, certain software may be sufficiently “smart” that it automatically alters an underlying “loop” or other recording of a real instrument (or a midi-created or similarly synthesized instrument) in a key in a certain rhythm to match an existing beats per minute, scale, and particular notes. Features popularly known as “autotune” can synthetically alter a series of piano notes, for example, to move up several notes to thereby match a desired key for a given audio track overall, even if those piano notes were previously recorded in another key. This is desirable as it enables real recordings of real instruments to be used without having to have huge amounts of audio track data stored for every possible key for a given track.

Search functions in such applications enable users to search for particular keywords such as “saxophone” or “piano” or “piccolo” for given instruments. Or, to search for percussion such as “deep bass drum” or “high hat.” But, at that point, users are relegated to cycling through each of the search results for a given search term, then listening to each, and searching for a series of notes, a series of musical measures, or a series of percussive sounds that matches or at least nearly-matches their desires for a given portion of an overall track. Even for well-organized databases of audio loops, this process is time consuming and can be overwhelming for users, particularly new users. This process is multiplied for each instrument that the user wishes to incorporate into a given track.

Then, each selected track must be laid out within software in an organized fashion, the beats per minute must be synchronized, the keys must be aligned, and the overall track must be arranged before the user can determine whether or not they have reached a desirable result. There is much artistry that can go into this process, and many pride themselves on doing it well. But, sometimes users wish to quickly get to a somewhat-working track or to simply jump start their creative process with ready-made, new tracks incorporating a plurality of audio loops (or samples) and to begin tweaking the overall audio track from a rough starting point with minimal effort required to get started. Such a “jump start” process may also enable newer users and music creators to get started from a half-finished track rather than having to start from a blank page every time. In that way, it may serve as an entryway to enable new users to get familiar with audio editing and mixing software.

It would be desirable if there were a way in which to employ a natural language model, preferably a large language model (LLM) to assist a user in selecting one or more tracks for a desired loop of audio, to automatically combine them, mix them, and to ensure that they are aligned with the same overall rhythmic structure and in the same key. This would eliminate some early-stage guesswork and time-consuming searching and lead to faster track or song generation using software that incorporates such processes.

### DESCRIPTION OF THE DRAWINGS

FIG. 1 is an overview of a system for language model audio selection and generation.

FIG. 2 is a block diagram of an exemplary computing device.

FIG. 3 is a functional block diagram of a system for language model audio selection and generation.

FIG. 4 is an example web page for generating audio using a language model.

FIG. 5 is an example web page having generated audio using a language model.

FIG. 6 is a flowchart of a process for generating audio using a language model.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

The advent of large language models (LLMs) has enabled communication with computers in a much more human form. LLMs enable software to mimic the communication styles of humans and to receive input data in a form much less formal and similar to one human communicating with another. However, LLMs are just that—large language models. They are for text-based communication. An input prompt generally works to create an output in some text form. LLMs can be trained to be quite adept at computer programming, which is essentially another language that they can learn and can be asked to respond tersely or verbosely. But, the generalized results are the same, namely, an ongoing conversation with a computer in a text form.

Certain artificial intelligence (AI) models have been given hybrid capabilities. For example, Google's newest Gemini AI (previously Bard) receives prompts in the form of text (usually) and can output images, videos, audio and, through plugins, can interact with a plurality of software options to act on smart home devices or to update spreadsheets within Google Sheets. Certain AI are capable of generating cogent multipart compositions or songs from text-based input prompts and playing them for users to hear. However, so far, no AI model or LLM has been able to take a text-based prompt and to generate a workable track (as opposed to a completed song or uneditable recording), including multiple distinct loops and to provide alternative loops for each track which may be used, therefrom.

The present patent pertains to the real-time creation of a multitrack audio sample incorporating elements selected through user text-based input of prompts. The method and system described herein relies upon receipt of a text-based prompt, informing the LLM of a desired song specification, using the LLM to translate the prompt into a plurality of keywords that may be used to search an existing database of audio loops, selecting a desired beats per minute (BPM) and scale and key, then sorting a plurality of available loops for at least two tracks (preferably four) to select a plurality of preferred loops, then automatically formatting selected loops for the desired BPM, scale, and key, and outputting a plurality of formed audio tracks (comprised of a plurality of loops) in conformity with the song specification and using the selected loops.

The plurality of audio tracks may then be used as a starting point for further revision and editing. The components of those tracks (e.g. the loops) may be either identified and automatically placed within a timeline (or track view) of an audio track editor or may be downloadable by the user to be incorporated into such an editor. And alternative loops may be provided for each selected loop to provide alternatives for a prospective editor or producer to swap out one or more of the selected loop to thereby tweak or alter the suggested track.

### Description of Apparatus

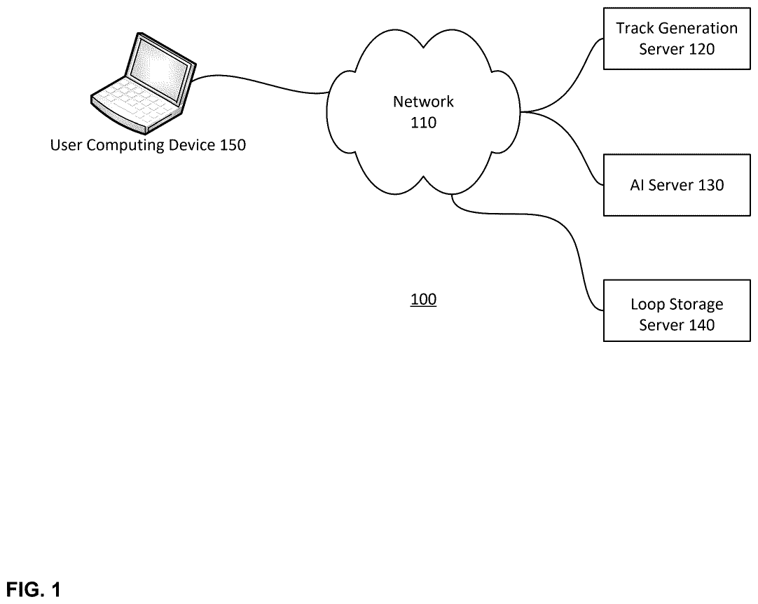

FIG. 1 is an overview of a system 100 for language model audio selection and generation. The system includes a track generation server 120, an AI server 130, a loop storage server 140, and a user computing device 150 all interconnected by a network 110.

The track generation server 120 is a computing device or computing devices that generates tracks from a user input text-based prompt. The track generation server 120 may incorporate a webs server to receive prompts from a user seeking to generate a track, then orchestrate communication with the rest of the elements of the system 100 using the network 110 to complete the process of track generation. The track generation server 120 also sends the AI server 130 any prompts along with a song specification format for use in generating a song specification for a given prompt and then, thereafter, selects loops to use for a track. Though shown as a single computing device, a plurality of computing devices or cloud-hosted service may be used for the track generation server 120.

The AI server 130 is a computing device or computing devices that receives a text-based prompt, along with a wrapper specifying a song specification format and then outputs a song specification based upon the prompt that may be used to select individual loops to be used in an overarching track by the track generation server 120. The AI server 130 is primarily responsible for using a large language model (LLM) to parse the user-input text prompt and to then format it into a file type that the track generation server can use to select loops from the loop storage server 140 to use for the desired track.

The loop storage server 140 is a computing device or computing devices that store a plurality of audio loops that may be used to create an overarching track. As used herein, the word “loop” will be used to describe a recording of a single instrument for a predetermined length of musical measures (e.g. four or eight measures) or time (e.g. 30 seconds). The word “track” will be used to refer to a musical composition involving at least two loops, joined in a way that they can be played or heard simultaneously with one another so as to create a combined musical composition. However, even when joined together, a track remains editable by a user to alter individual loops (e.g. alter tones, BPM, placement within the track, etc.), swap out one or more loops making up the track for other loops or to otherwise alter the track. In this way, a track is distinct from a pure sound recording that is uneditable and merely able to be played by suitable audio reproduction hardware or software.

The loop storage server 140 may incorporate an API (application programming interface) enabling the track generation server 120 and the AI server 130 to communicate with the loop storage server 140 to make requests, search its loops, or otherwise interact with the loop storage server 140 to accomplish the tasks described herein. The loop storage server 140 may incorporate or use a database (hosted on the loop storage server 140 or hosted on another computing device or devices or on the cloud) to categorize the loops stored thereon in any number of ways including the instrument in the loop, the volume of the loop, the beats per minute (bpm) of the loop, the key of the loop, the scale of the loop (major or minor), any user-input or automatically generated keywords describing the loop (e.g. Caribbean, folk, funk, marching band, guitar lick, somber, happy, upbeat, etc.), and other characteristics of the loop that may be searchable or otherwise relevant for use by the track generation server 120 or the AI server 130 in generating a track using the loop.

The user computing device 150 is a computing device or computing devices that are used by a user to input a text-based prompt to begin the process of track generation in communication with the track generation server 120. The user computing device is shown as a laptop computer, but may be any computing device such as a tablet computer, a mobile device, or a desktop computer. The user computing device 150 interacts with the web server that is a part of (or associated with) the track generation server 120 to begin the process of track generation discussed herein.

The network 110 is or may include the internet. The network 110 enables communication between the various computing devices described herein.

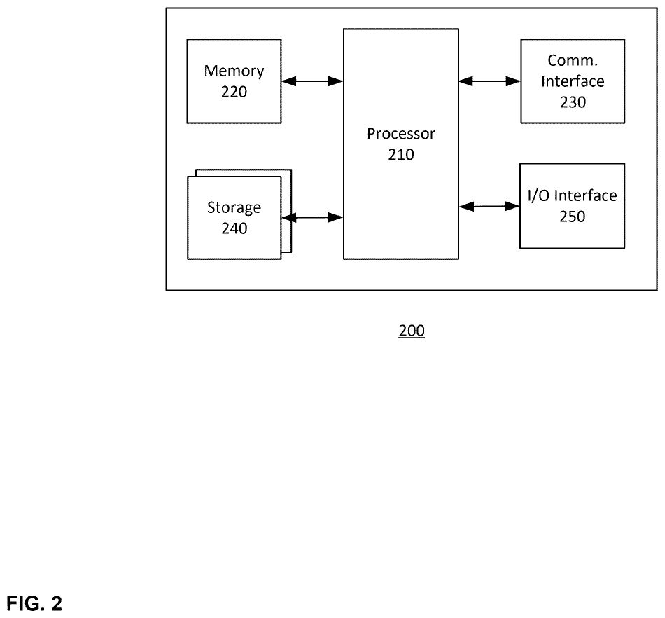

FIG. 2 is a block diagram of an example computing device 200, which may be or be a part of the track generation server 120, the AI server 130, the loop storage server 140, the user computing device 150 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The application can perform the functions described herein.

The communications interface 230 may include one or more wired interfaces (e.g. a universal serial bus (USB), high-definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display and one or more input devices such as a touch screen, keypad, keyboard, stylus or other input devices. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine-readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

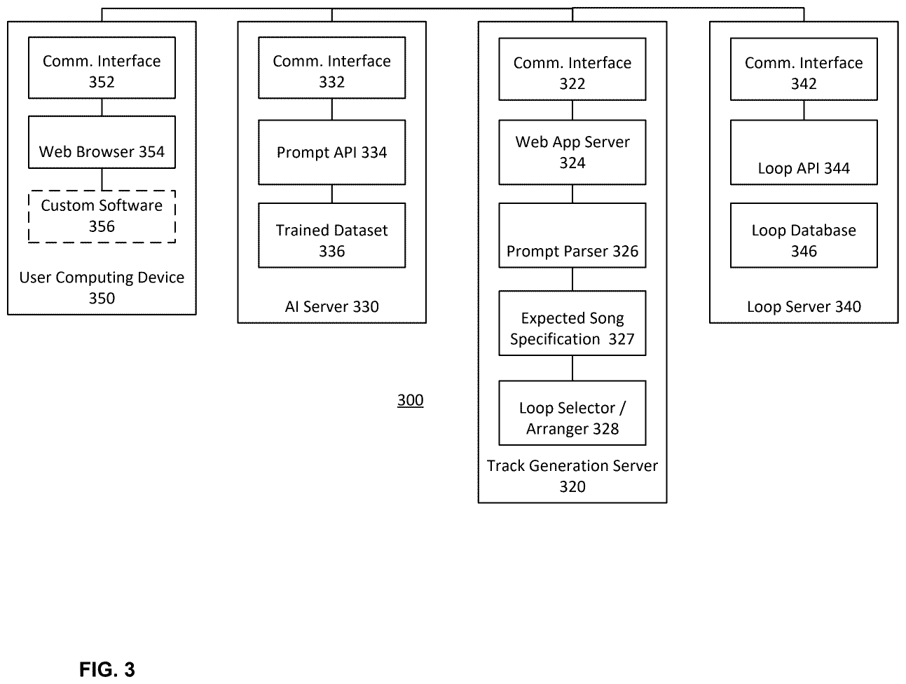

FIG. 3 is a functional block diagram of a system 300 for language model audio selection and generation. The system 300 includes a track generation server 320, an AI server 330, a loop server 340, and the user computing device 350, which correspond to the servers and device of the same name in FIG. 1. In FIG. 3, these computing devices are shown in functional format so that their purposes and uses may be discussed. The functions shown in a single computing device may be spread across many. And in certain cases, some functions attributed to different servers may be joined within a single server. For example, AI functions of the AI server 330 may be integrated into the track generation server 320 in some cases.

The track generation server 320 includes a communications interface 322, a web app server 324, a prompt parser 326, an expected song specification 327, and a loop selector/arranger 328. These are functional components which may be structurally or physical organized in another form other than shown here.

The communications interface 322 is responsible for enabling communication between the track generation server 320 and the other components of the system 300. The communications interface 322 may include traditional networking functions such as TCP/IP communications, wireless 802.11x or ethernet functions, but may also include custom software or software front-ends suitable for interacting with the various components of the system 300. In general, the track generation server 320 will interact with all of the other components of the system 300.

The web app server 324 performs many functions, operating as the primary point of contact for the track generation server 320. The web app server 324 operates to present a web page to a user device for inputting a text-based prompt, parses the prompt reliant upon a song specification file format, which is a desired format for a song specification that may be subsequently used to generate a track from a plurality of loops, then interacts with the AI server 330 using the prompt and song specification file format, to receive a song specification and use that specification to select loops from a database of available loops to generate a plurality of tracks matching the requirements of the song specification.

The web app server 324 is an application running on the track generation server 320 that operates to generate a web application, which may be, include or interact with a web server software, to serve a web application to user devices, such as user computing device 350, that enables that user to input a text-based prompt.

The web app server 324 may present an interactive web page or series of web pages that request a text-based prompt for a desired track to be created and then outputs a plurality of proposed tracks. The web app server 324 may include an application programming interface (API) such that it can perform a similar function in interaction with custom software (e.g. custom software 356) on a user computing device.

Preferably, the web app server 324 receives a text-based prompt and then wraps the text-based prompt in a meta-prompt with added instructions on how to generate a suitable song specification file format (discussed below) in response. Thereafter, the web app server 324 may use a song specification, including all of the preferred characteristics of the desired song (e.g. the track) to select a subset of loops matching associated criteria input in the text-based prompt, and to generate one or more tracks in response.

The prompt parser 326 is a sub-function or application within the track generation server 320 that operates to receive a text-based prompt from the user and perform the wrapping process. In the wrapping process, the text-based prompt is formatted to incorporate the desired form of the song specification file format to instruct the AI server 330 in the desired song specification format.

The expected song specification 327 is the file format or output format that the track generation server 320 desires to receive output in so as to be able to operate upon the resulting output from the AI server 330 to generate one or more options for a track from the input text-based prompt. An example of a song specification file format generated in response to a text-based prompt of “intro to a scifi adventure movie” is shown in Appendix A.

The expected song specification 327 may change over time and be revised through learning as to how best to represent the data for the track generation server. The expected song specification 327 is a preferred format for the song specification that the track generation server 320 wishes to receive. In the present invention, the preferred format is a response including the desired data as a .json file. A json file is a desirable format because it can store data in an organized format, but one that is also readable (and able to be output) by a large language model. Other file formats for the song specification could be used such as comma separated value tables, extensible markup language, or other text-based or machine- and human-readable file formats. The json file format is merely a design choice that is easily usable in the present system.

The song specification file format includes a beats per minute range, a scale, a description of desired loops to use within a track, a genre, a mood, a listing of how “important” a given loop is to the track as a whole (to determine which to prioritize when choices are between two loops in the final track), an instrument or instrument type, a function associated with the loop, any “tags” that may be searchable keywords associated with relevant loops, as well as an identification of any required tags for a loop or any forbidden tags for a loop (e.g. tags, like labels for a given loop in the loop database 346, that must be present in a search for a loop or that must not be present). The same information types are present in the song specification file format for each desired loop in a track. Preferably, this is four loops, but it may be as few as two or a virtually infinite number of loops.

The song specification may include other characteristics of a particular loop to be included in a track including the function of the loop (e.g. rhythm, lead, melody, harmony, etc.), a mood of the track, any amount of panning or effects used in the track, and the overall importance of the particular track (e.g. if a user specifically requests one type of instrument or track be present in a prompt or it is necessary for a particular genre of music or type of requested track.

The desired elements of each loop are listed in such a song specification file format. And, when the AI server 330 returns its results in response to the prompt, a song specification outlining each of the details shown in the song specification file format is returned in the song specification file format. The track generation server 320 may then operate using the data present in the song specification provided by the AI server 330 to select individual loops using the loop server 340.

The loop selector/arranger 328 is a sub-function or application that relies upon the song specification generated by the AI server 330 to select suitable loops for use within a track based upon the user input text-based prompt. The loop selector/arranger 328 selects a relevant beats per minute (BPM) for the track, selects a scale, selects a key (potentially based upon one or more loops it selects), and then semi-randomly selects a series of loops. The loop selector/arranger 328 may also format the loops appropriately and lay them out (or create and/or pass data sufficient to lay them out) in a track view for editing using custom software 356 and/or generate a midi file for the selected loops and/or generate an audio file or stream that may be heard by a user of the track generation server 320.

The loop selector/arranger 328 performs the primary function of selecting relevant loops that are appropriate based upon the user input text-based prompts and arranging them as a musical composition. For a given text-based input prompt, the loop selector/arranger 328 may generate a plurality of options such as 2 tracks or 4 tracks or 10 tracks, each with different outputs reliant upon pseudorandom selection of loops or semi-random selection of loops. The options enable a user to select from several potential tracks that may spur creativity or provide a starting point for more work, while also allowing a user to ignore those that are not appropriate or otherwise seem undesirable.

As discussed more fully below, the loop selector/arranger 328 may generate selection criteria for each loop making up a given track. The selection criteria may then be compared with options for each loop using weightings for desired characteristics (e.g. appropriate key, BPM, genre, etc. as discussed more fully below). Thereafter, a subset of loops matching most or all criteria are listed, in an order determined by how well they meet the criteria. Finally, among the best-matching loops (e.g. the top 3 or top 10), a randomness may be employed to select one of those best-matching loops. This process helps to interject some randomness into the process for variation in output, particularly when multiple options for tracks are being generated. But, it is not so random that the prompt's requests are entirely ignored or even partially-ignored. Basically, this process enables the loop selector/arranger 328 to “randomly” select among a group of very good options near the end of the process of selecting loops. Of course, as a result, the selected loops tend to be good matches for the desired characteristics.

The AI server 330 includes a communications interface 332, a prompt API 334, and a trained dataset 336. These are functional components which may be structurally or physical organized in another form other than shown here. The AI server 330 may be a commercial large language model such as Gemini, Co-Pilot, or ChatPGT created by Google®, Microsoft® and OpenAI, respectively. Or, the AI server 330 may be a self-operated, special purpose LLM (or derivative of a commercial LLM). The AI server 330 may be self-hosted for security and privacy or may be specially-trained on audio-related datasets.

The communications interface 332 is responsible for enabling communication between the AI server 330 and the other components of the system 300. The communications interface 332 operates in the same general fashion as the communications interface 322 discussed above.

The prompt API 334 is a sub-function or application of the AI server 330 that enables a direct communication of a text-based (or other) prompt. In this way, the track generation server 320 may receive the prompt using the web app server 324 and may pass that prompt on to the AI server 330 using the prompt API 334. The prompt API 334 also is responsible for returning results from the AI server 330 to a user of the prompt API 334. So, the AI server 330 may parse the text-based prompt transmitted via the prompt API 334, and may then respond with a suitable output response using the same prompt API 334.

The trained dataset 336 is a large language model dataset. These datasets are complex and large, but in general are based upon large portions of textual, human-written communications. These can be books, articles, blogs, web forums, and the like. The trained dataset 336 enables the AI server 330 to utilize its large language model (LLM) to respond to user input, text-based prompts. Most LLMs can both receive inquiries in relatively normal written language and respond, seemingly intelligently, to those inquiries in written language. The LLMs rely upon the trained dataset to generate relevant responses.

In the case of the usage described herein, the AI server 330 parses the user input text-based prompt to “understand” its request. The track generation server 320 has wrapped the prompt in a meta prompt that incorporates instructions and includes the layout of the expected song specification 327 so that the AI server 330 knows the desired file format. Thereafter, the AI server 330 may respond in the desired format with appropriate keywords and elements necessary for the song specification in view of the user input text-based prompt.

Because the AI server 330 has been trained (e.g. the trained dataset 336) to understand communication by humans, it can parse the user input text prompt, parse its meaning, then output the associated characteristics or conjecture or suggest characteristics for the song proposed by the user. So for example, if a user inputs a prompt of “eerie scifi music featuring a jazz piano,” then the AI server 330 can extrapolate naturally from eerie and scifi to use tense, sustained strings or other notes (e.g. synth), a slow or unstructured beat or rhythm, and to incorporate a jazz piano with syncopation or other jazz-related characteristics. The AI server 330 can fill in the blanks of the song specification with suggestions or requirements for a loop and/or track to conform to the user input text-based prompt. This can occur in a fashion similar to what a human composer would do in response to input from a director or their own mind pushing through experience and desired outcomes for a given track.

The loop server 340 includes a communications interface 342, a loop API 344, and loop database 346. These are functional components which may be structurally or physical organized in another form other than shown here.

The communications interface 342 is responsible for enabling communication between the loop server 340 and the other components of the system 300. The communications interface 342 operates in the same general fashion as the communications interfaces 322 and 332 discussed above.

The loop API 344 is an accessible application programming interface that may be interacted with by the loop selector/arranger 328 of the track generation server 320. Once the track generation server 320 receives the song specification generated from the prompt by the AI server 330, then it can use the song specification and the loop API 344 to peruse the available loops on the loop server 340. The loop API 344 enables searching (e.g. using keywords or bpm or genre or other song elements or indexes), selection, and potentially copying and playback of loops that may be incorporated into a track by the track generation server 320. The loop API 344 may also operate in an input/response format such that it receives properly formatted inputs and responds in an expected format in response. In this way, the track generation server 320 may submit inputs using the loop API 344 and expect responses in a format that may be computer processed for accessing and obtaining the desired loops.

The loop database 346 is a subfunction or application and/or database that stores information pertaining to the loops available as well as the loops themselves (or links to the loops themselves). The loop database 346 may be either or both of human and computer curated such that its indexes for searching may include a beats per minute of a loop, a scale, a description of a genre, a mood, potential types of music to which the loop may pertain or be useful (e.g. jazz and marching beats or western films or cold war), an instrument or instrument type, a function associated with the loop, any “tags” that may be searchable keywords associated with each loop (e.g. “guitar riff,” or “brass horns” or “drum roll” and the like). Other tags, keywords, categorization, or the like may also be included in any loop database 346 indexes that may be searched using the loop API 344.

The loop API 344 preferably also includes the capability to easily “sample” the loop. Herein this means that, for a given loop, the user or the track generation sever 320 itself may easily initiate playback of a sample of the loop or the loop itself while not necessarily downloading the entire loop beforehand. In this way, a selected loop may be listened to or accessed before downloading by a user, for example, as a stream directly from the web app server 324.

The user computing device 350 includes a communications interface 352, a web browser 354, and, optionally, custom software 356. These are functional components which may be structurally or physical organized in another form other than shown here. The user computing device 350 primarily requests a language model assisted track generation using a user input text-based prompt and receives the results of the output by the track generation server 320. The user computing device 350 must receive that prompt and forward it on to the track generation server 320, but otherwise is primarily passive in the processes described herein. In some cases, the user computing device may simultaneously perform all of the functions of the track generation server 320 and the user computing device 350 on a single computing device.

The communications interface 352 is responsible for enabling communication between the user computing device 350 and the other components of the system 300. The communications interface 352 operates in the same general fashion as the communications interfaces 322, 332, and 342 discussed above.

The web browser 354 is software operating on the user computing device 350 that enables web browsing. Typical software includes programs like Mozilla® Firefox® web browser or the Microsoft® Edge® browser or Google® Chrome browser. However, the web browser 354 may instead be or be built into other software, such as audio file editing software or music editing or creation software.

The custom software 356 is yet another option for the user computing device 350. It is an optional component, presented in dashed lines. The custom software 356 may be an entirely custom software that includes the capability to rely upon AI generated suggested tracks from a database of available loops. Or, the custom software 356 may be built into other software such as audio file editing software or music editing or creation software. In such a case, the user computing device 350 may perform all of the functions of the track generation server 320.

### Description of Processes

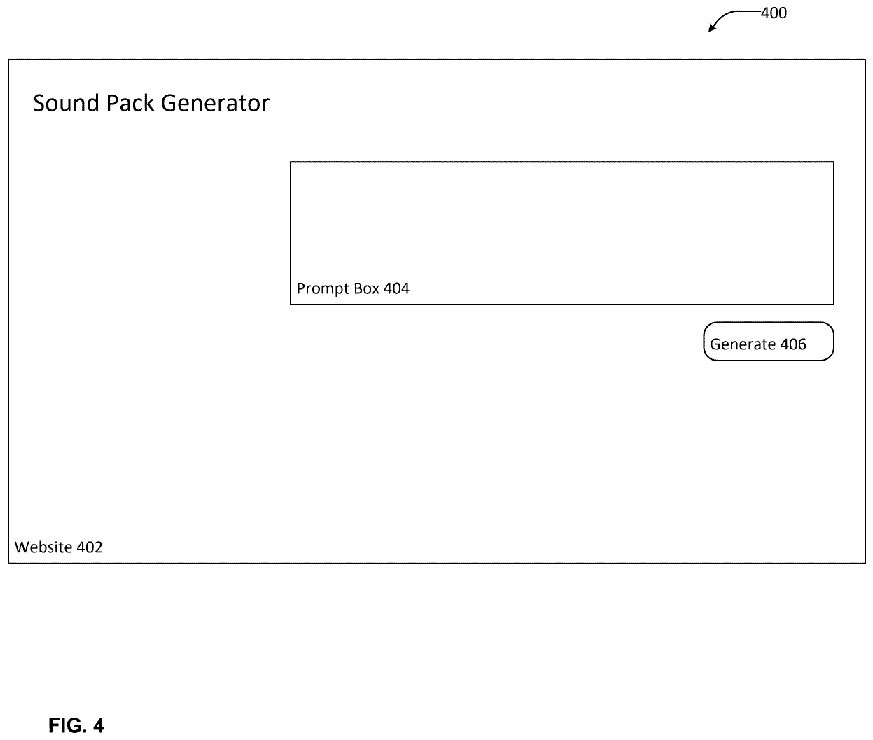

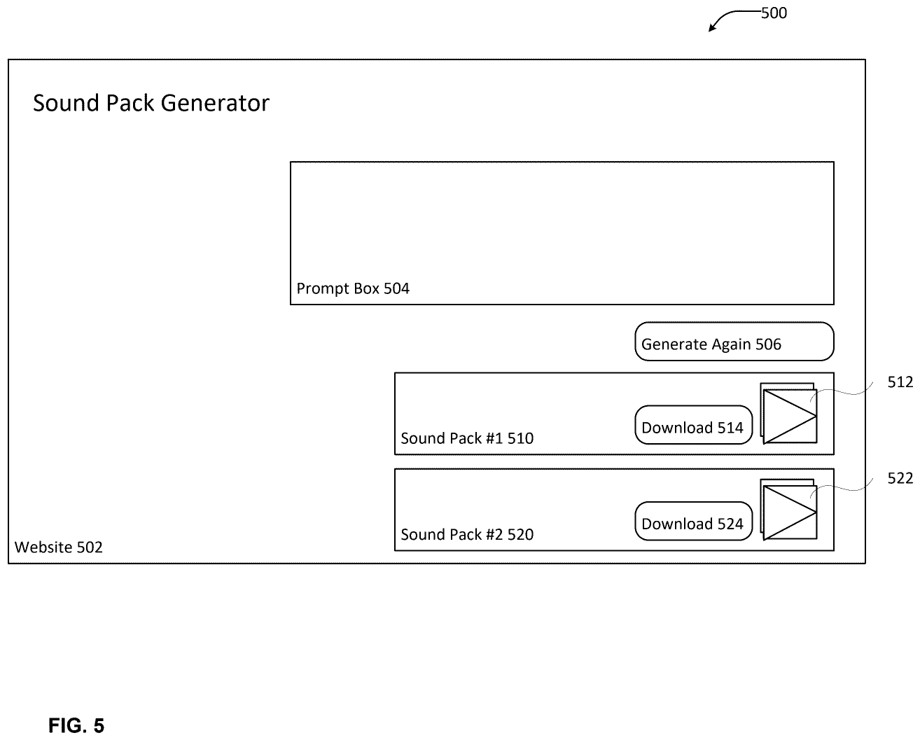

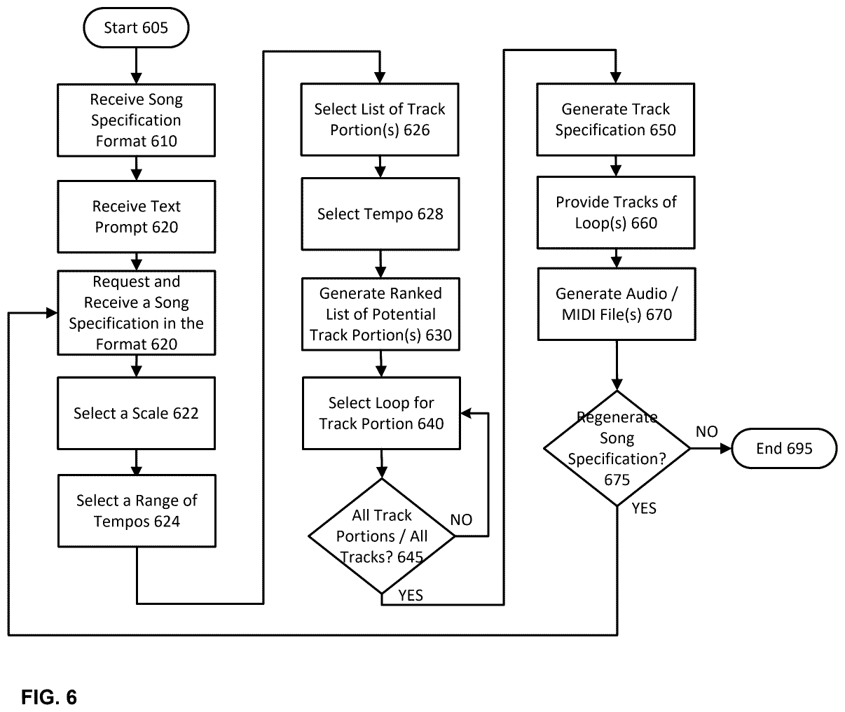

FIGS. 4 and 5 are example web pages for generating audio using a language model. Each will be discussed below with reference to FIG. 6.

FIG. 6 is a flowchart of a process for generating audio using a language model. The flowchart has a start 605 and an end 695, but may take place many times or many processes may be simultaneously being executed by the same or different users at the same time or substantially the same time.

Following the start 605, the process begins with receipt of a song specification file format at 610. Here, the file format to be used for the song specification is received by the track generation server 320 and stored as the expected song specification 327. Preferably this is a .json file, but it may be any number of file types as discussed above. This may be the first time the track generation server 320 is started or may be received periodically or on-demand as the expected file format of the song specification changes from time to time or is otherwise updated. In some cases, this step may not take place at all if there is no update.

Next, the track generation server 320 receives a user input text-based prompt. This prompt is likely input on the user computing device 350 using the web browser 354 to interact with the web app server 324 on the track generation server 320. FIG. 4 shows a web page 400 in a browser window showing a website 402 which is for a sound pack generator. The website 402 has a prompt box 404 which is a text box into which a user may type a text-based prompt. This web page is shown on the web browser 354, though it is loaded form the web app server 324 in response to an appropriate HTTP (hypertext transfer protocol) request. Once a text-based prompt is input, the user may select the generate button 406 to begin the generation process.

Returning to FIG. 6, the next step in the process, request and receive a song specification in the format 620, is initiated by selecting the generate button 406 in FIG. 4. Several elements take place simultaneously at this point. The track generation server 320 receives the user input text-based prompt. The track generation sever 320 then wraps the user input text-based prompt in some instructions and a preferred song specification file format in which to receive a reply. The song specification file format is needed to enable the track generation server 320 to operate upon the song specification and select appropriate loops.

The wrapped text-based prompt is then transmitted to the AI server 330 to request and receive a song specification at 620. The song specification does not explicitly identify individual loops to use, but merely provides a suggested framework from which the track generation server 320 may operate to select several options for loops to include in a completed track or group of tracks. The AI server 330 performs that function and receives the song specification provided by the AI server 330. Then, the AI server 330 generates a song specification based upon the user input text-based prompt.

The generated song specification identifies a number of desirable or required attributes of each loop to be included in a completed track. The song specification includes a beats per minute range, a scale, a description of desired loops to use within a track, a genre, a mood, a listing of how “important” a given loop is to the track as a whole (to determine which to prioritize when choices are between two loops in the final track), an instrument or instrument type, a function associated with the loop, any “tags” that may be searchable keywords associated with relevant loops, as well as an identification of any required tags for a loop or any forbidden tags for a loop (e.g. tags, like labels for a given loop in the loop database 346, that must be present in a search for a loop or that must not be present). The same information types are present in the song specification file format for each desired loop in a track. Preferably, this is four loops, but it may be as few as two or a virtually infinite number of loops. And, different or other information may be included without diverging from the intended scope of the present patent.

Among the elements generated for the song specification is a selected scale (e.g. major or minor). The next step is the track generation server 320 selects a scale at 622. Based upon the user input text-based prompt, this scale may be mandatory (e.g. a scary horror theme or a music for somber funeral scene likely is minor) or may be optional, dependent upon the song specification created by the AI server 330. The track generation server 320 selects the scale to help identify loops in the loop database 340 that may be relevant or suitable.

Next, the song specification identifies a range of tempos that may be suitable for the track at 624. The track generation server 320 selects a tempo within the range of tempos at 624. This may be randomly selected, or the AI server 330 may suggest a slower tempo for a more somber or sad song or a faster tempo for a more elated or upbeat song. A range is used to enable the track generation server 320 to generate alternative tracks with different tempos to provide variety in a group of generated tracks for the user to choose between.

Next, a list of track portion(s) is selected at 626. Here, the track generation server 320 uses the song specification to select options for each track portion in the desired track. The song specification preferably utilizes a plurality of potential loops (e.g. four loops) and describes desired characteristics of each loop. Here, the potential track portions (each to be filled with a loop) are selected. So, the song specification may identify several options for instruments, mood, tone, genre, etc. for each of the track portions (e.g. loops to be added a future track based upon the song specification). In this step, the track generation server 320 selects particular attributes that are required or that will be present in a selected track so that it can later use that information (along with the scale, tempo, etc.) to select loops. This selection may not be a true selection, but in some cases may be an ordered list of preferred characteristics that can be later used to generate a weighted mean which can be used to select an individual loop for a track portion.

For example, the track generation server 320 may rely upon the AI responses in the song specification to identify attributes of desirable loops for a given track portion. The characteristics may identify instruments or instrument types, keywords used to describe the loops or that would describe desirable loops, tempos used on the loops or time signatures used on the loops. Various other attributes may be represented in the song specification and the list of track portion(s) may be selected to correspond to those attributes. Aspects of the prompt input at 620 may be, in a sense, translated at this stage to enable the system to choose suitable track portion(s).

Next, a tempo is selected by the track generation server 320 at 628. The song specification may provide a range of potential tempos, while the track generation server may randomly select from within that range to select a tempo at 628.

Next, the track generation server 320 generates a ranked list of potential track portion(s) at 630. Here, each of the track portion(s) (e.g. four loops to be added to a track or searched for then added to a track) are ordered in their attributes and identified with desirable and mandatory attributes. This enables the track generation server 320 to select loops matching those characteristics and to know which of the track portions to prefer or hold as more important (e.g. a marching beat may be required if it is specifically requested by the text prompt, so it may be weighted as mandatory or very highly). The various attributes of the track portions may be presented as weighted components making up a whole. This enables loops to be compared using a weighted mean to determine how closely they match for desired attributes or characteristics of the user input desired song.

Some of the elements that may be considered in the weighted mean include loop tags, the scale (major or minor) of the loop, BPM of the loop, the rhythm used in the loop, whether or not the loop will harmonize with the other loop(s), and any tags, lines, kits (e.g. drums, guitar, etc.) or specific loops included verbatim or explicitly within the user input text prompt. In addition, another neural network or networks may be applied only to the task of translating the text based prompt (or portions thereof) to audio content and/or audio descriptors. This neural network is in addition to the more general purpose LLM or AI that may be applied to the prompt as a whole. One recent example of such a neural network is called CLAP (Contrast Language-Audio Pretraining). CLAP is an audio-specific neural network trained on audio/text pairs and reliant upon encoder correlation. It has been shown to be particularly adept at matching text to audio in a manner that more-closely mimics human understanding of music when described in text. Though this neural network is one example, other networks, LLMs, or AI may serve this purpose as well to act as an intermediary matching text to audio and then providing grades of the extent each available loop for a prospective track meets the desired criteria/text based prompt.

Next, the track generation server 320 searches for and selects loops for each of the track portions at 640, using the list of potential track portion(s) generated at 630. Preferably, each portion of a given track is generated at once or substantially at the same time by searching through the loop database 346 to identify tracks whose weighted mean match best with the track portion(s) identified in the song specification. For example, as seen in the Appendix A below, numerous desirable or optional or required characteristics may be identified with each track portion in the song specification. For required elements, the weighting may be 100%, whereas for desired characteristics or optional characteristics, weightings may intentionally fluxuated or randomized to enable the track generation server 320 to select slightly-different loops for each track portion each time the process is run (e.g. for four, example tracks being created from one song specification file).

The loops may be placed in a ranked list, then only the top may be selected for each track portion or some leeway or randomness may be introduced to enable the selection from among a subset, such as the top five tracks in the ranked list. Alternatively, loops may be compared with one another to identify similarities or loops that are more likely to go better together (e.g. similar key, same scale, similar bpm, similar time signature, etc.) and such a comparison may be added as an additional weighting in the selection process to enable the system to select loops that will go well together. Or, still further alternatively, a main sound loop may be selected (e.g. a good loop for a melody for a proposed song specification) and other loops may be weighted for their analogousness to or suitability to be joined with the main sound loop (e.g. rhythmic format, tempo, bpm, scale, time signature, etc.).

In addition, it is preferable for a plurality of optional tracks to be generated for each user input text-based prompt. So, the user is presented with options for a given prompt. In some cases, the AI server 330 and track generation server 320 may really select excellent options for the loops for a given track. In other cases, one or more loops may be unusual, or otherwise unsatisfactory. So, by running the operation several times, with slightly different weightings for the various attributes, the overall optional resulting tracks may better suit the user's desires.

Alternatively, or in addition to slightly different weightings, once a subset of loops for a given track are identified, and they are weighted from most-alike the prompt to least-alike the prompt, then the semi-randomness described above is applied wherein a random selection from among the most-matching tracks may be selected. Thereafter, for each iteration of optional tracks, the selected tracks may be excluded, and the same semi-randomness may be applied to the remaining loop options. As a result, every optional track (e.g. each of the four options for a given track) will employ different loops.

Next, a determination whether all tracks and all track portions have been filled is made at 645. If not (“no” at 645), then another loop is selected for a remaining track portion at 640.

If so (“yes” at 645), then the process continues with generation of a track specification. This document identifies specific loops that will be placed within the track to be generated. The track specification may be instructions how to build the track or may incorporate links and other information necessary to synchronize the loops with one another and line up their tempos, BPM, and other attributes.

Next, the tracks are provided including the selected loop(s) at 660. Here, each track is presented to the track generation server 320 and/or to the user computing device 650 for review. As a part of that audio and/or MIDI (musical instrument digital interface) file(s) may be generated for each track or each loop individually at 670. Other lossy (or non-lossy) audio files may be provided. For immediate purposes (e.g. for listening to each option), lossy audio may be used via the web app server 324. For use within audio editing software, the lossless audio files may be provided separately.

An example interface for providing access to the previews is shown in FIG. 5. Here, the web page 500 still shows the same website 502, but following generation of the associated tracks. The same prompt box 504 appears, and an option to generate again button 506 is shown in place of the original generate 406 button from FIG. 4. Now, however, two different sound packs #1 510 and #2 520 are shown. Preview buttons 512 and 522 may be provided to enable a user to “stream” or otherwise hear a preview of the generated tracks. And, download buttons 514 and 524 or similar links may be provided to enable a user to access the actual files to be used for the track(s) and/or loop(s). In some cases, alternative loops for each track portion (e.g. those that were highly-ranked, but not the highest-ranked) may be provided as a part of the download function to enable a user to edit, alter, or tweak a track with desirable attributes. Or, to enable a user to have access to near-selected tracks that may better-suit a desired sound.

If the user is not pleased with the results, the user may elect to regenerate the song specification at 675. If a user does so (“yes” at 675), then the process begins again with request and receipt of a song specification in the format 620. This may be initiated with the generate again button 506 in FIG. 5. If not (“no” at 695), then the process ends at 695.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for selecting and generating audio comprising a computing device for:
receiving from a user a text-based prompt for a desired song having characteristics identified within the text-based prompt;
generating a song specification from a prompt that includes the text-based prompt and instructions on how to create a desired instruction file format for representing the requested song, the song specification in the instruction file format comprising:
a suggested scale,
a range of tempos for the song,
a list of tracks for the song, each of the list of tracks comprising:
one or more instruments for use on each track,
a musical function of the one or more instruments,
a list of tags that describe the sonic qualities of the one or more instruments;
selecting a tempo from within the range of tempos;
for each of the list of tracks in the song specification, generating a ranked list of potential sound loops matching the song specification for a selected track;
selecting a sound loop from the ranked list of potential sound loops for each of the list of tracks; and
generating a track specification file including the sound loop selected for each of the list of tracks.

2. The system of claim 1 wherein the ranked list is created using an evaluation based upon a selected two criteria of: a number of shared tags from the list of tags that correspond to tags within the song specification, whether the sound loop is in the same musical scale as the suggested scale from the song specification, whether the sound loop is in the same musical key as a suggested key from the song specification, a comparison of tags for the sound loop to the text-based prompt, whether the sound loop matches rhythmic features of a selected main sound loop, whether the sound loop matches harmonic features of the selected main sound loop, whether a suggested beats-per-minute from the song specification is within a desired beats-per-minute range of the sound loop, the application of a second neural network or language model for matching input text with sound loops, whether the sound loop matches chord progression features of a selected main sound loop, and if the sound loop matches the chord progression features of the selected main sound loop.

3. The system of claim 2 wherein a weighted mean is applied to a score for each of the selected two of criteria with an adjustment applied such that only those sound loops within the ranked list having a mean within a predetermined threshold remain in a weighted, ranked list.

4. The system of claim 3 wherein a sound loop from the weighted, ranked list is selected pseudo-randomly using a probability based upon its respective weighted mean relative to other sound loops within the weighted, ranked list.

5. The system of claim 1 wherein the computing device is further for repeating the processes of selecting a tempo, generating a ranked list of potential sound loops, selecting a sound loop from the ranked list of potential sound loops, and generating a track specification file for a predetermined number of track specifications greater than two.

6. The system of claim 1 wherein the computing device is further for:
generating a render specification from the track specification, the render specification identifying all selected sound loops for a particular track specification, any effects to be applied to the selected sound loops, a beats per minute for the selected sound loops, and a key and scale for the selected sound loops; and
generating a midi file to enable playback of the render specification.

7. The system of claim 6 wherein the computing device is further for creating an audio file pursuant to the render specification.

8. The system of claim 6 wherein the computing device is further for providing access to at least a selected one of:
the audio file and midi file with only a portion of a loop for each of the selected sound loops;
the audio file and the midi file with an entire example arrangement and mix for the selected sound loops; or
a plurality of audio files as a series of alternative tracks, each of the plurality of audio files being a plurality of potential sound loops for each of the list of tracks.

9. A method for selecting and generating audio, the method comprising:
receiving from a user a text-based prompt for a desired song having characteristics identified within the text-based prompt;
generating a song specification from the prompt that includes the text-based prompt and instructions on how to create a desired instruction file format for representing the requested song, the song specification in the instruction file format comprising:
a suggested scale,
a range of tempos for the song,
a list of tracks for the song, each of the list of tracks comprising:
one or more instruments for us on each track,
a musical function of the one or more instruments,
a list of tags that describe the sonic qualities of the one or more instruments;
selecting a tempo from within the range of tempos;
for each of the list of tracks in the song specification, generating a ranked list of potential sound loops matching the song specification for a selected track;
selecting a sound loop from the ranked list of potential sound loops for each of the list of tracks; and
generating a track specification file including the sound loop selected for each of the list of tracks.

10. The method of claim 9 wherein the ranked list is created using an evaluation based upon a selected two criteria of: a number of shared tags from the list of tags that correspond to tags within the song specification, whether the sound loop is in the same musical scale as the suggested scale from the song specification, whether the sound loop is in the same musical key as a suggested key from the song specification, a comparison of tags for the sound loop to the text-based prompt, whether the sound loop matches rhythmic features of a selected main sound loop, whether the sound loop matches harmonic features of the selected main sound loop, whether a suggested beats-per-minute from the song specification is within a desired beats-per-minute range of the sound loop, the application of a second neural network or language model for matching input text with sound loops, whether the sound loop matches chord progression features of a selected main sound loop, and if the sound loop matches the chord progression features of the selected main sound loop.

11. The method of claim 10 wherein a weighted mean is applied to a score for each of the selected two of criteria with an adjustment applied such that only those sound loops within the ranked list having a mean within a predetermined threshold remain in a weighted, ranked list.

12. The method of claim 11 wherein a sound loop from the weighted, ranked list is selected pseudo-randomly using a probability based upon its respective weighted mean relative to other sound loops within the weighted, ranked list.

13. The method of claim 9 further comprising repeating the processes of selecting a tempo, generating a ranked list of potential sound loops, selecting a sound loop from the ranked list of potential sound loops, and generating a track specification file for a predetermined number of track specifications greater than two.

14. The method of claim 9 further comprising:
generating a render specification from the track specification, the render specification identifying all selected sound loops for a particular track specification, any effects to be applied to the selected sound loops, a beats per minute for the selected sound loops, and a key and scale for the selected sound loops; and
generating a midi file to enable playback of the render specification.

15. The method of claim 14 further comprising creating an audio file pursuant to the render specification.

16. The method of claim 14 further comprising providing access to at least a selected one of:
the audio file and midi file with only a portion of a loop for each of the selected sound loops;
the audio file and the midi file with an entire example arrangement and mix for the selected sound loops; or
a plurality of audio files as a series of alternative tracks, each of the plurality of audio files being a plurality of potential sound loops for each of the list of tracks.

17. A non-volatile machine-readable medium storing a program having instructions which when executed by a processor will cause the processor to:
receive from a user a text-based prompt for a desired song having characteristics identified within the text-based prompt;
generate a song specification from the prompt that includes the text-based prompt and instructions on how to create a desired instruction file format for representing the requested song, the song specification in the instruction file format comprising:
a suggested scale,
a range of tempos for the song,
a list of tracks for the song, each of the list of tracks comprising:
one or more instruments for us on each track,
a musical function of the one or more instruments,
a list of tags that describe the sonic qualities of the one or more instruments;
select a tempo from within the range of tempos;
for each of the list of tracks in the song specification, generating a ranked list of potential sound loops matching the song specification for a selected track;
select a sound loop from the ranked list of potential sound loops for each of the list of tracks; and
generate a track specification file including the sound loop selected for each of the list of tracks.

18. The apparatus of claim 17 wherein the ranked list is created using an evaluation based upon a selected two criteria of: a number of shared tags from the list of tags that correspond to tags within the song specification, whether the sound loop is in the same musical scale as the suggested scale from the song specification, whether the sound loop is in the same musical key as a suggested key from the song specification, a comparison of tags for the sound loop to the text-based prompt, whether the sound loop matches rhythmic features of a selected main sound loop, whether the sound loop matches harmonic features of the selected main sound loop, whether a suggested beats-per-minute from the song specification is within a desired beats-per-minute range of the sound loop, the application of a second neural network or language model for matching input text with sound loops, whether the sound loop matches chord progression features of a selected main sound loop, and if the sound loop matches the chord progression features of the selected main sound loop.

19. The apparatus of claim 17 wherein the instructions further cause the processor to:
generate a render specification from the track specification, the render specification identifying all selected sound loops for a particular track specification, any effects to be applied to the selected sound loops, a beats per minute for the selected sound loops, and a key and scale for the selected sound loops;
generating a midi file to enable playback of the render specification; and
create an audio file pursuant to the render specification.

20. The apparatus of claim 17 further comprising:
the processor; and
a memory,
wherein the processor and the memory comprise circuits and software for performing the instructions on the storage medium.
